(19) United States
(12) Patent Application Publication
(10) Pub. No.: US 2011/0024151 A1
(43) Pub. Date: Feb. 3, 2011

(54) CABLE

(75) Inventors: Hirotaka Eshima, Hitachi (JP); Fumihito Oka, Hitachi (JP); Ryoji Mizutani, Nagoya-shi (JP); Kenji Ishida, Nagoya-shi (JP)

Correspondence Address: FOLEY AND LARDNER LLP;SUITE 500, 3000 K STREET NW, WASHINGTON, DC, 20007, US

(73) Assignees: HITACHI CABLE, LTD.; TOYOTA JIDOSHA KABUSHIKI KAISHA

(21) Appl. No.: 12/776,044

(22) Filed: May 7, 2010

(30) Foreign Application Priority Data
Aug. 3, 2009 (JP) 2009-180692

(51) Int. Cl. H01B 7/00; H02G 3/04

(52) U.S. Cl. 174/24; 174/68.1; 174/113 C

(57) ABSTRACT

A cable includes a plurality of stranded wires substantially arranged annularly and each formed by twisting a plurality of conductor wires, and an inclusion disposed substantially at a center of the plurality of stranded wires. The inclusion includes spiral grooves, each of which being provided for fitting each of the stranded wires thereinto, that are each shaped according to a part of an outer surface of the stranded wires and separated by a dividing wall provided for preventing two adjacent stranded wires of the plurality of stranded wires from contacting each other.

The present application is based on Japanese patent application No. 2009-180692 filed on Aug. 3, 2009, the entire contents of which are incorporated herein by reference.

### BACKGROUND OF THE INVENTION

1. Field of the Invention

This invention relates to a cable and, in particular, to a cable used for an environment where bending is repeatedly applied, such as robots and automobiles.

2. Description of the Related Art

For example, a cable for automobiles used in the environment where bending is repeatedly applied, such as an unsprung portion (a portion under a suspension device) of the automobiles where bending is repeated according to movement of wheels is needed to have not only high bending durability, but also, for example, high flexibility in terms of ease of routing work. However, it has been difficult to satisfy both high bending durability and high flexibility.

FIG. 5 is a cross-sectional view schematically showing a conventional cable.

The cable 51 is composed of a stranded wire conductor 53 formed by together twisting plural stranded wires (child stranded wires) 52 (FIG. 5 shows an example of seven stranded wires 52 twisted together) formed by twisting plural conductor wires together, and an insulation layer 56, a shielding layer 57, a reinforcing braided layer 58 and a sheath 59 which are arranged sequentially from inside on the periphery of the stranded wire conductor 53.

Related arts to the invention are, e.g., JP-A-2002-124137 and JP-A-2004-172019.

However, none of the related arts discloses a cable for achieving both high bending durability and high flexibility.

### SUMMARY OF THE INVENTION

It is an object of the invention to a cable that has both high bending durability and high flexibility by reducing contact between stranded wires so as to prevent the cable from abrasion or disconnection caused by bending.

(1) According to one embodiment of the invention, a cable comprises:

a plurality of stranded wires substantially arranged annularly and each formed by twisting a plurality of conductor wires; and

an inclusion disposed substantially at a center of the plurality of stranded wires,

wherein said inclusion comprises spiral grooves, each of which being provided for fitting each of the stranded wires thereinto, that are each shaped according to a part of an outer surface of the stranded wires and separated by a dividing wall provided for preventing two adjacent stranded wires of the plurality of stranded wires from contacting each other.

In the above embodiment (1), the following modifications and changes can be made.

(i) The dividing wall is located at a position for exhibiting a shortest distance between said two adjacent stranded wires.

(ii) The cable further comprises an insulation layer on an outer perimeter of the plurality of stranded wires, a shielding layer outside the insulation layer, and a sheath outside the shielding layer.

(iii) The cable further comprises a reinforcing braided layer formed of a shock absorption fiber and is disposed between the shielding layer and the sheath.

(iv) The inclusion is formed tubular.

(v) The inclusion is formed of a resin material.

(vi) The resin material comprises a flexible resin material.

(vii) The resin material comprises a resin material with a low friction coefficient.

(viii) The plurality of conductor wires comprise lubricating oil coated thereon.

(ix) The lubricating oil comprises silicone oil.

Points of the Invention

According to one embodiment of the invention, a cable comprises an inclusion that is provided with spiral grooves, each of which being provided for each of stranded wires, that are each shaped according to a part of the outer surface of the stranded wire and separated by a dividing wall which is provided for preventing two adjacent stranded wires from contacting each other. Therefore, the physical contact between the stranded wires can be reduced by putting each of the stranded wires into the groove of the inclusion. In addition, the physical contact between the stranded wires can be more surely reduced by locating the dividing wall at a position for exhibiting the shortest distance between two adjacent stranded wires. Thus, the abrasion or disconnection caused by bending can be significantly reduced as compared to the conventional cable.

### BRIEF DESCRIPTION OF THE DRAWINGS

The preferred embodiments according to the invention will be explained below referring to the drawings, wherein:

FIG. 1 is a cross-sectional view schematically showing a cable according to one embodiment of the invention;

FIG. 2 is a side view and cross-sectional view schematically showing an example of an inclusion used in the invention;

FIG. 3 is a cross-sectional view schematically showing a cable according to another embodiment of the invention;

FIG. 4 is an explanatory view schematically showing a bending durability test; and

FIG. 5 is a cross-sectional view schematically showing a conventional cable.

### DETAILED DESCRIPTION OF THE PREFERRED EMBODIMENTS

The preferred embodiments according to the invention will be explained below referring to the drawings.

Prior to the present invention, the inventor has proposed, in Japanese patent application No. 2009-105307, a cable using an inclusion for having both high bending durability and high flexibility. This application discloses a structure that only plural stranded wires (i.e., child stranded wires) are twisted, wherein an inclusion (i.e., a central inclusion) at the center of the conductor is disposed for preventing abrasion or disconnection of wires caused when the stranded wires (child stranded wires) mutually contact and rub at a strong contact surface pressure in bending, so that the central inclusion deforms first such that the abrasion or disconnection of wires can be prevented by reducing the contact surface pressure caused between the stranded wires (child stranded wires).

However, even in the cable with the central inclusion, the stranded wires (child stranded wires) may contact mutually in physical aspect. Thus, the present invention aims at further securely preventing the abrasion or disconnection of wires in bending.

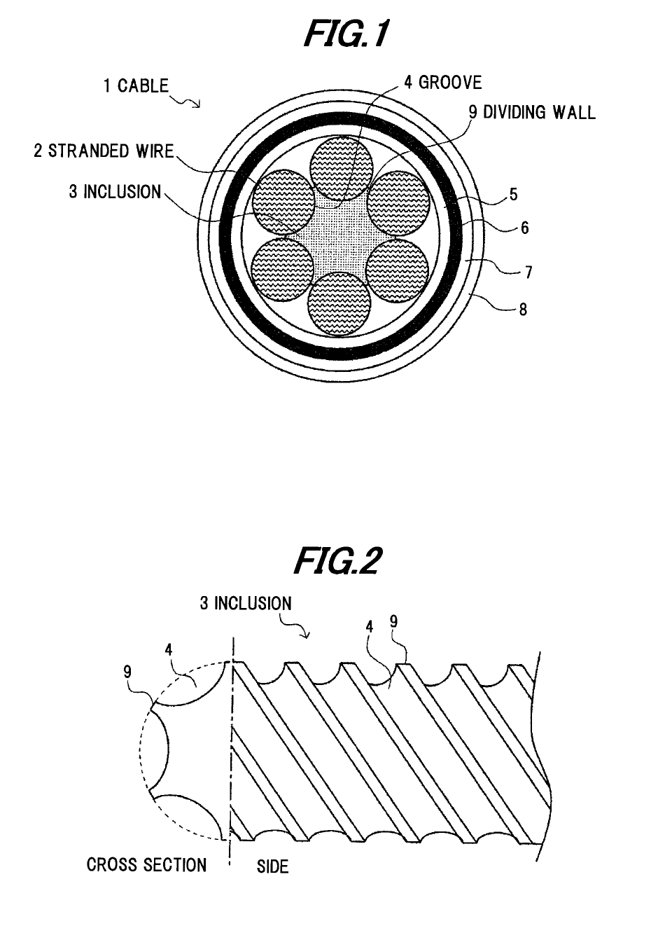

As shown in FIG. 1, the cable 1 of the embodiment comprises plural stranded wires (child stranded wires) 2 arranged substantially annularly and each formed by twisting plural conductor wires, and an inclusion 3 disposed substantially at the center of the stranded wires 2 arranged substantially annularly. The inclusion 3 is provided with spiral grooves 4, each of which being provided for each of the stranded wires 2, that are each shaped according to a part of the outer surface of the stranded wire 2 and separated by a dividing wall 9 which is provided for preventing two adjacent stranded wires 2 from contacting each other.

The dividing wall 9 may be located at a position for exhibiting the shortest distance between two adjacent stranded wires 2.

In this embodiment, as shown in FIG. 1, six stranded wires 2 are disposed substantially annularly such that the centers (axes) of the six stranded wires 2 are on the circumference of a single circle with a same radius. However, within the scope of the invention, plural stranded wires may be disposed substantially annularly such that the centers (axes) of plural stranded wires are alternately on the different circumferences of circles with different radiuses. Further, plural stranded wires may be disposed substantially annularly such that the centers (axes) of plural stranded wires are on the circumference of an ellipse.

The cable 1 includes, on the outer perimeter of the stranded wires 2, an insulation layer 5, a shielding layer 6, a reinforcing braided layer 7 and a sheath 8 arranged sequentially from the inner side. The reinforcing braided layer 7 arranged between the shielding layer 6 and the sheath 8 is a braid of a shock absorption fiber. Further, the presence or absence of the shielding layer 6 and the sheath 7 is not particularly limited.

FIG. 2 shows an outline of the inclusion 3. The inclusion 3 has six grooves formed thereon since the six stranded wires 2 are disposed significantly annularly in the cable 1. The shape of the groove 4 is semicircular in cross section thereof but may be V-shaped, concave, inverted trapezoidal or the like.

On the outermost perimeter of the inclusion 3, the dividing walls 9 are formed between two adjacent grooves 4. Thereby, the stranded wires 2 accommodated in the grooves 4 are protected from contacting each other by the dividing walls 9.

The inclusion 3 is preferably formed of a resin material. The resin material preferably has flexibility and a low friction coefficient.

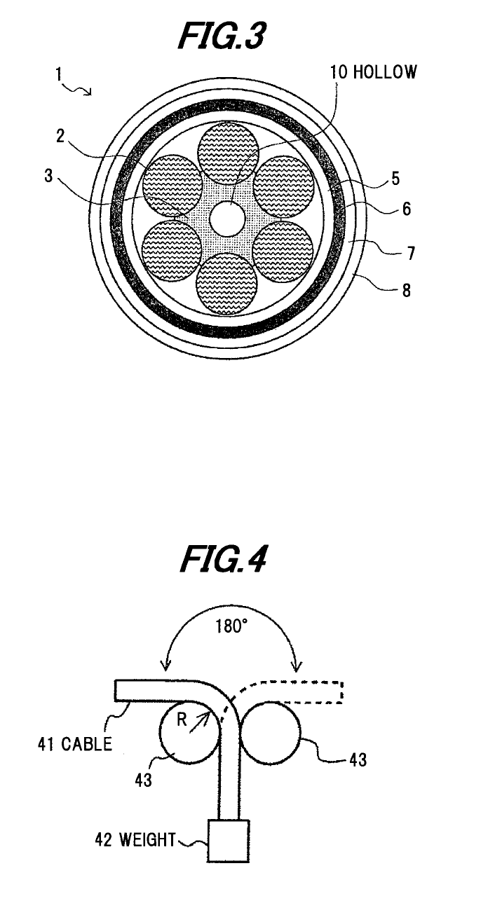

The inclusion 3 may be, as shown in FIG. 1, formed solid (i.e., not hollow in its entire body) from the center to the outer perimeter, or may be, as shown in FIG. 3, formed tubular such that it has a hollow 10 for allowing more flexibility.

The functions and effects of the cable 1 will be explained below.

The conventional cable 51 including no inclusion shown in FIG. 5 have no clearance to which the stranded wires (child stranded wires) 52 can escape in bending, so that the stranded wires 52 mutually contact and rub at a strong contact surface pressure in bending, whereby the abrasion or disconnection of wires may be caused. To solve this problem, the inventor has proposed, in Japanese patent application No. 2009-105307, the cable that the central inclusion deforms first such that the abrasion or disconnection of wires can be prevented by reducing the contact surface pressure caused between the stranded wires (child stranded wires). However, even in the cable with the central inclusion, the stranded wires (child stranded wires) may contact mutually in physical aspect, so that the abrasion or disconnection of wires may not be completely prevented.

By contrast, in the cable 1 of the embodiment, as shown in FIGS. 1 and 3, the inclusion 3 is provided with spiral grooves 4, each of which being provided for each of the stranded wires 2, that are each shaped according to a part of the outer surface of the stranded wire 2 and separated by the dividing wall 9 which is provided for preventing two adjacent stranded wires 2 from contacting each other. Therefore, the physical contact between the stranded wires 2 can be reduced by putting each of the stranded wires 2 into the groove 4 of the inclusion 3. In addition, the physical contact between the stranded wires 2 can be more surely reduced by locating the dividing wall 9 at a position for exhibiting the shortest distance between two adjacent stranded wires 2.

Thus, the physical contact between the stranded wires 2 is reduced such that the abrasion or disconnection caused by bending can be significantly reduced as compared to the conventional cable.

In the embodiment, the six stranded wires 2 are arranged nearly in an annular form in cross section of the cable 1 and the inclusion 3 is arranged nearly at the center of the six stranded wires 2 arranged nearly in the annular form. Thus, since the stranded wires 2 are arranged nearly in annular form, the outer shape of the cable 1 can be formed circular in cross section thereof. Also, due to the circular shape, the cable 1 can be rendered excellent in design.

Further, in the embodiment, the six stranded wires 2 are used, but two to five or seven or more stranded wires 2 can be used within the scope of the invention. In this case, the number of the grooves 4 may be adjusted according to the number of the stranded wires 2 used.

The conductor wires may be coated with lubricant oil such as silicone oil. When the conductor wires is coated with lubricant oil, the abrasion or disconnection can be reduced even if the stranded wires (child stranded wires) 2 formed by twisting the conductor wires physically contact each other.

### EXAMPLES

A cable 1 of Example 1 having the cable structure shown in FIG. 3 and a cable 1 of Example 2 having the cable structure shown in FIG. 1 are produced as well as a cable 51 of Comparative Example having the cable structure shown in FIG. 5.

Examples 1, 2 and Comparative Example have substantially the same cable structure except that Examples 1, 2 have the inclusion 3 and Comparative Example does not have the inclusion 3.

The stranded wires (child stranded wires) 2 were formed by twisting tin-plated annealed copper wires of 0.08 mm in diameter as the conductor wires. Further, the stranded wires (child stranded wires) 2 were twisted into a stranded wire conductor while they are fitted into the grooves 4 that are each shaped according to a part of the outer surface of the stranded wire 2 and separated by the dividing wall 9 which is provided for preventing two adjacent stranded wires 2 from contacting each other. The external diameter of the stranded wires (child stranded wires) 2 is 1.0 mm.

The inclusion 3 of Example 1 is a silicone tube with Shore hardness A of 50.

The inclusion 3 of Example 2 is formed of a PTFE (polytetrafluoroethylene) resin.

The inclusion 3 of Example 2 is about 2.0 mm in outermost diameter, and the width of the dividing wall 9 is set such that the shortest distance between two adjacent stranded wires 2 becomes 0.1 mm.

The insulation layers 5, 56 were formed of cross-linked polyethylene.

The shielding layers 6, 57 were formed of a tin-plated copper wire.

The reinforcing braided layers 7, 58 were formed of polyvinyl alcohol fibrous material (polyethylene terephthalate fibrous material or polyethylene-2, 6-naphthalate fibrous material may be alternatively used).

The sheaths 8, 59 were formed of ethylene-propylene-diene rubber.

Performance comparison was carried out by measuring bending durability and bending rigidity.

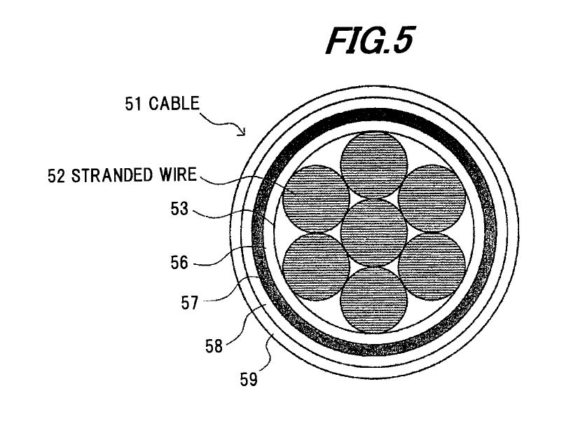

First, with regard to the cables of Examples 1, 2 and Comparative Example, a bending durability test that the cables are bent more than once by 180 degrees from side to side with a bending radius R 30 (according to IEC (International Electrotechnical Commission) 60227-2 Electrical Appliances Technical Standard) was carried out. The test method is shown in FIG. 4.

As shown in FIG. 4, a weight 42 is fixed to a lower end of a cable 41 so as to apply a load to the cable 41, and the cable 41 is sandwiched between jigs 43, 43 having a curved surface for giving the bending radius R 30 to the cable 41. A cycle that a part of the cable 41 located at upper portion than the jigs 43, 43 is bent from a left-pointing horizontal position to a right-pointing horizontal position, and then the part of the cable 41 is returned to the left-pointing horizontal position is defined as one cycle. The cycle is repeated, and number of the cycles when the stranded wire 2 is broken is checked.

TABLE 1

| | Number of bending cycles |
|---|---|
| Example 1 | Not less than half-million |
| Example 2 | Not less than half-million |
| Comparative Example | Ten thousand |

As shown in Table 1, in case of the cable 51 of Comparative Example, the stranded wire 2 was broken at ten thousand cycles of the bending, but in case of the cable 1 of Examples 1 and 2, the stranded wire 2 was not broken even at half-million cycles of the bending, and it is clear that Examples 1, 2 are remarkably excellent in bending durability in comparison with Comparative Example.

Next, with regard to the cables of Examples 1, 2 and Comparative Example, bending rigidity to the bending radius R was measured.

Here, the “bending radius R” means a bending radius in a place where the cable is curved at a maximum when the cable is bent. The “bending rigidity” means an index showing difficulty in bending, which is represented as the product of longitudinal elastic modulus and geometrical moment of inertia. The bending radius R was set to 150, 80, 50 and 30 mm.

TABLE 2

Bending radius R (mm)

| | 150 | 80 | 50 | 30 |
|---|---|---|---|---|
| Comparative | 1 | 1 | 1 | 1 |
| Example | | | | |
| Example 1 | 0.7 | 0.65 | 0.62 | 0.61 |
| Example 2 | 0.9 | 0.88 | 0.62 | 0.82 |

As shown in Table 2, when the bending rigidity in the cable 51 of Comparative Example is defined as 1, all of the bending rigidities in the cable 1 of Examples 1, 2 became smaller than 1 of the bending rigidity in the cable 51 of Comparative Example. As seen from the above, the cable 1 of Examples 1, 2 improved in flexibility than the cable 51 of Comparative Example.

From the above-mentioned results, it has become clear that the cable 1 of Examples 1, 2 have higher bending durability and higher flexibility than the cable 51 of Comparative Example.

Further, in Example, the cable including both the shielding layer 6 and the sheath 8 was shown, in case of a cable including either of the layers, the same result can be obtained.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A cable, comprising:
a plurality of stranded wires substantially arranged annularly and each formed by twisting a plurality of conductor wires; and
an inclusion disposed substantially at a center of the plurality of stranded wires,
wherein said inclusion comprises spiral grooves, each of which being provided for fitting each of the stranded wires thereinto, that are each shaped according to a part of an outer surface of the stranded wires and separated by a dividing wall provided for preventing two adjacent stranded wires of the plurality of stranded wires from contacting each other.

2. The cable according to claim 1, wherein the dividing wall is located at a position for exhibiting a shortest distance between said two adjacent stranded wires.

3. The cable according to claim 1, further comprising:
an insulation layer on an outer perimeter of the plurality of stranded wires;
a shielding layer outside the insulation layer; and
a sheath outside the shielding layer.

4. The cable according to claim 3, further comprising:
a reinforcing braided layer formed of a shock absorption fiber and disposed between the shielding layer and the sheath.

5. The cable according to claim 1, wherein the inclusion is formed tubular.

6. The cable according to claim 1, wherein the inclusion is formed of a resin material.

7. The cable according to claim 6, wherein the resin material comprises a flexible resin material.

8. The cable according to claim 6, wherein the resin material comprises a resin material with a low friction coefficient.

9. The cable according to claim 1, wherein the plurality of conductor wires comprise lubricating oil coated thereon.

10. The cable according to claim 9, wherein the lubricating oil comprises silicone oil.
